(19) United States
(12) Patent Application Publication
(10) Pub. No.: US 2008/0251216 A1
(43) Pub. Date: Oct. 16, 2008

(54) Fabric Window Shade With Front Wavy Pattern Based Upon Double-Weaving Fabric

(76) Inventor: Kai-Sheng Hsu, Walnut, CA (US)

Correspondence Address: LAW OFFICES OF J.F. LEE, 17800 CASTLETON STREET, SUITE 383, CITY OF INDUSTRY, CA, 91748, US

(21) Appl. No.: 11/733,892

(22) Filed: Apr. 11, 2007

(51) Int. Cl. E06B 3/00

(52) U.S. Cl. 160/84.01

(57) ABSTRACT

A type of fabric window shades that produce desirable wavy pattern, even at the state of full deployment, is disclosed and claimed herein. Horizontal junctions of two layers, with back layers shortened in each fold, produce desired wavy pattern comparable to that of Roman shades, at the shades' naturally deployed state, even without pulling up/down the window shade.

### FIELD AND BACKGROUND OF THE INVENTION

The present invention relates generally to the construction of fabric window shade that is generally referred to as Roman shades.

Roman shades in general consist of a front fabric panel backed with a drapery lining. There are several “folds” on a Roman shade. At the back (the drapery lining) of each “fold”, there are two or more lift rings, through which lift cords are threaded, and achieving the wavy folds pattern, when the shade is pulled up, or dropped down, depending on the specific implementation. A repetitive wavy pattern exists naturally as a result of the folds and the horizontal lines of lift rings.

Present invention discloses and claims the construction of wavy pattern that resembles the result on Roman shade, but is based upon double-weaving fabric to make the wavy patterns even without pulling up or dropping down some of the folds, and thus is a simpler and more efficient way of producing Roman-shade-like feature.

### DESCRIPTION OF THE DRAWINGS

The accompanying drawings, which are incorporated in and constitute a part of this specification, illustrate the preferred embodiments of the invention and together with the description, serve to explain the principles of the invention.

A brief description of the drawings is as follows:

FIG. 1 shows the fabric window shade made by using a double-weaving fabric having a front layer and a back layer, containing a number of folds when the two layers are joined together horizontally at fixed intervals.

FIGS. 2a and 2b show the creation of wavy pattern by overlapping some portion of back layer.

FIGS. 3a, 3b and 3c show the creation of wavy pattern by shortening center portion of back layer per each fold.

### DETAILED DESCRIPTION OF THE PREFERRED EMBODIMENT

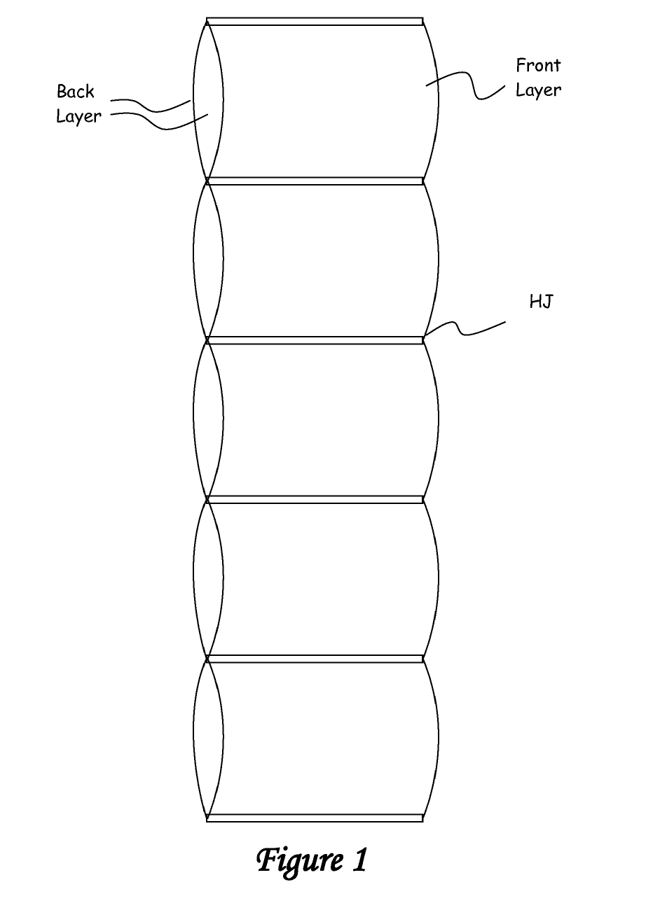

In FIG. 1, the basic construction of a fabric window shade pursuant to disclosure herein is shown. Some length of fabric is used in front layer and in back layer. The two layers of the double-weaving fabric can be made from different materials. The two layers are joined together horizontally at a fixed interval, along the vertical orientation, as shown in FIG. 1.

A fold is formed between any two horizontal junctions, labeled as HJ.

For the horizontal junction, it can be done by stitching together, glued together, or other methods generally known in the industry and requires no disclosure herein and does not formed part of the claimed subject matter herein.

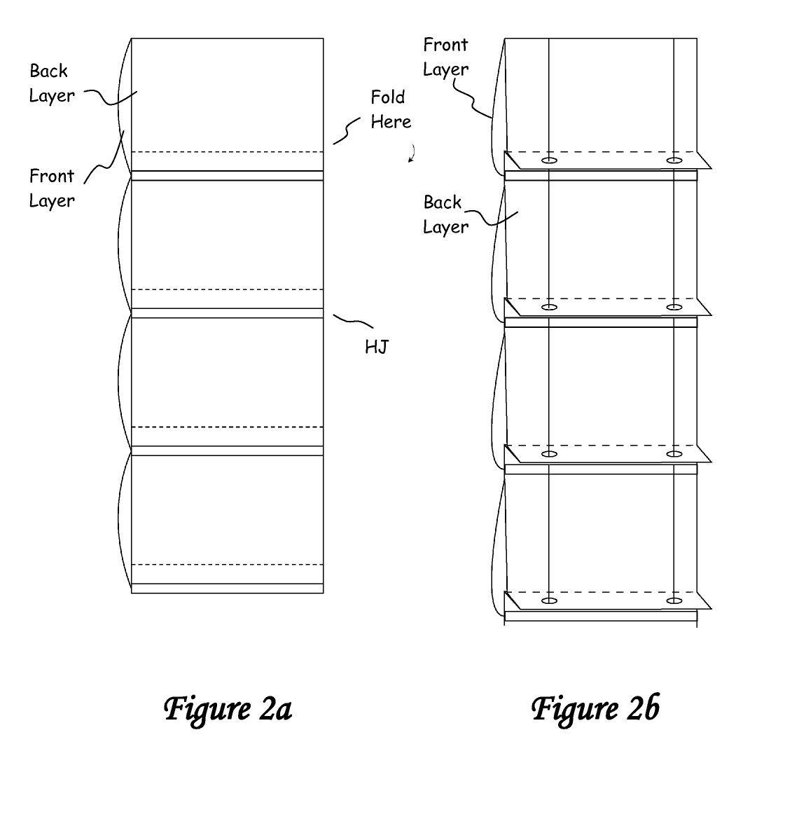

In FIGS. 2a and 2b, it can be seen that in each fold, a portion of back layer is folded out, causing an overlapping area. Two holes can then be cut out on the overlapping area, allowing pull cords to string through.

Plastic or other rigid material of ring structure can be affixed to the cut out holes, to protect the edges of the holes from being frayed quickly due to the friction of the pull cords.

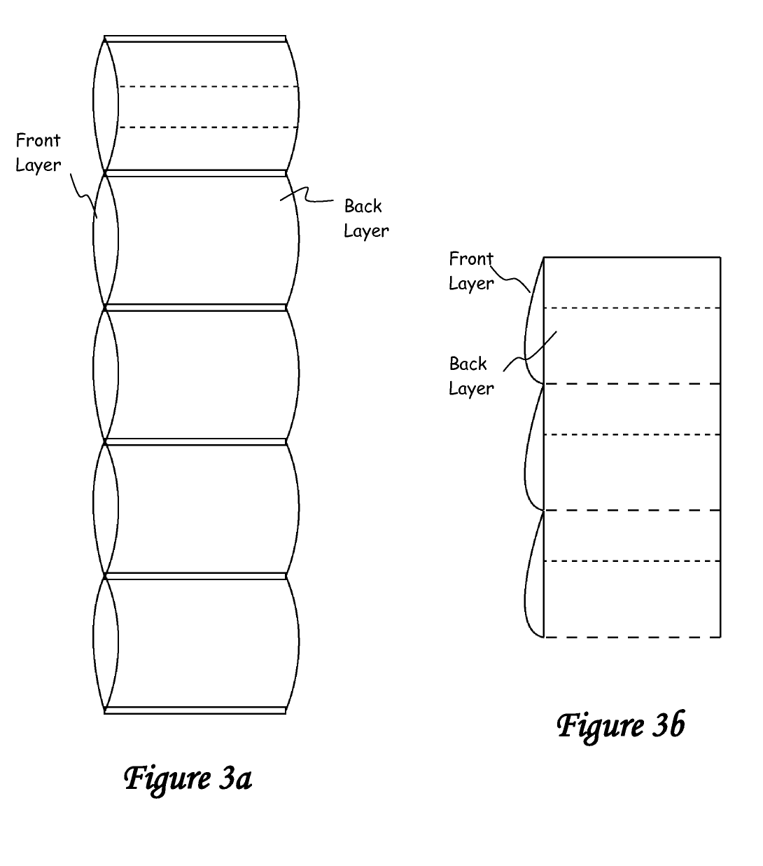

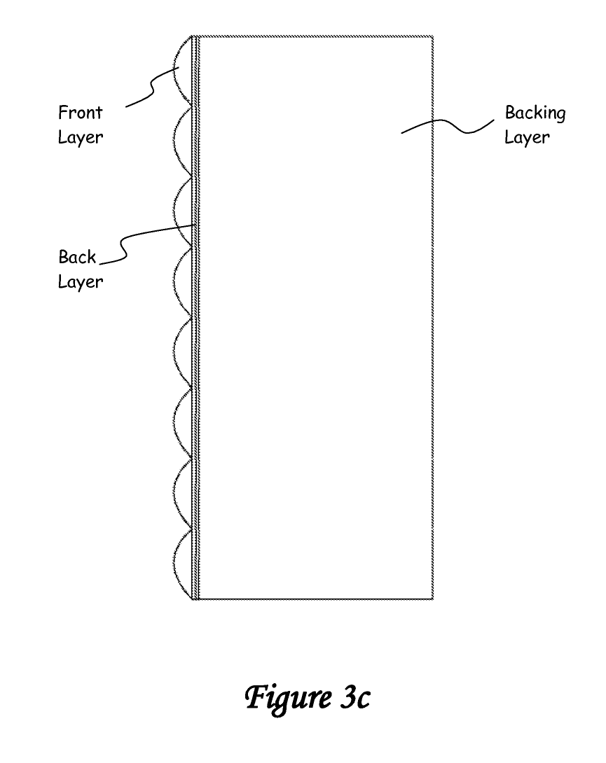

In FIGS. 3a and 3b, it can be seen some length on the back layer can be shortened up, producing the wavy pattern on each fold.

The shortening can be done by cutting away a portion, then rejoining the remaining back layer, in each fold, thus resulting the desired wavy pattern.

In addition, wavy pattern can also be produced, as depicted in FIG. 1, when the back layer is made from a material that shrinks more than the front layer, after the two layers are subjected to same treatment/processing, such as washing.

In FIG. 3c, a further backing layer is added, so that the holes, or any pull cords used to pull up/down of the window shade can be hidden from view.

The window shade made pursuant to present invention contains desirable wavy patterns, even at time when the window shade is fully deployed. In contrast, Roman shades as generally available today on the market produce the desired wavy pattern only when the shades are either pulled up, pulled down, but not at the naturally deployed state.

By using double-weaving fabric to produce the wavy pattern similar to Roman shade, present invention introduces an easy and efficient way of doing that.

What is claimed is:

1. Fabric window shade, comprising:
a double-weaving fabric having a front layer and a back layer wherein the two layers are joined together horizontally at fixed intervals, forming a fold in each interval;
wherein a portion of back layer is horizontally pulled out, forming an overlapped area; and,
wherein two holes are cut out from the overlapped area in the back layer of each fold, allowing pull cords to string through.

2. Fabric window shade of claim 1, further comprising rigid ring structures sized to fit said two holes, protecting the edges of said holes from the friction of pull cords.

3. Fabric window shade of claim 1, further comprising a backing layer of the same length of the back layer, so that the overlapped area and the pull cords are covered up from being seen.

4. Fabric window shade, comprising:
a double-weaving fabric having a front layer and a back layer wherein the two layers are joined together at fixed intervals, forming a fold in each interval; and,
wherein the back layer is made of material that shrinks more than the front layer when receiving further treatment, so that the front layer contains wavy pattern per each fold.

5. Fabric window shade, comprising:
a double-weaving fabric having a front layer and a back layer wherein the two layers are joined together at fixed intervals, forming a fold in each interval; and,
wherein a portion of back layer on each fold is shortened up, causing a wavy pattern to appear in the front layer in each fold.

6. Fabric window shade of claim 5, wherein the shortening up of back layer on each fold is done by horizontal cutting away of some portion and then rejoining the remaining back layer on each fold.

7. Fabric window shade of claim 5, wherein the shortening up of back layer on each fold is done by horizontal overlapping of some portion on the back layer on each fold.
